(19) United States
(12) Patent Application Publication
(10) Pub. No.: US 2013/0024265 A1
(43) Pub. Date: Jan. 24, 2013

(54) Programmable Customer Loyalty and Discount Card

(71) Applicant: Marc Lotzof, San Diego, CA (US)

(72) Inventor: Marc Lotzof, San Diego, CA (US)

(21) Appl. No.: 13/551,888

(22) Filed: Jul. 18, 2012

Related U.S. Application Data
(60) Provisional application No. 61/510,911, filed on Jul. 22, 2011.

(51) Int. Cl. G06Q 30/02

(52) U.S. Cl. 705/14.27

(57) ABSTRACT

A programmable loyalty and discount card system and methods is described. The card is programmable through pre-set and updateable preferences and actions associated with the preferences. Logically incompatible actions are reconciled at time of use of the card through priorities set at the time of initial registration. Participants and users of the system may include multiple retailers, consumers and data users who provide the service to consumer participants through a service provider.

### CROSS-REFERENCE TO RELATED APPLICATIONS

This application claims priority to U.S. Provisional application 61/510911, by the same inventor entitled Discount Card filed on Jul. 22, 2011 and currently pending.

### BACKGROUND OF THE INVENTION

1. Technical Field

The present invention relates to a system and methods for a loyalty and discount card.

2. Related Background Art

Customer loyalty and discount cards and coupons have existed for a long time. The advent of electronics and small storage devices such as memory chips and magnetic strips have resulted in electronic versions of discount coupons, prepaid cards such as prepaid phone cards and prepaid buying cards. There are also membership cards such as buying clubs that allow registered users/owners to obtain goods at a particular retail establishment at a discounted price. With the advent of increased graphically encoded information such as in QR Code ® type encoding (QR Code is a registered trademark of Denso Wave Inc. a corporation of Japan) and ubiquitous presence of smart phones, tablets and similar portable computing devices it is possible to graphics on cards carried by consumers to link with web page and other programs on the Internet. However this possibility is yet to be fully realized. Consumers still carry unique loyalty and discount cards for each business. Coupons are still clipped individually. The discount cards are typically read at the retailer checkout to provide discounts at time of paying at a particular retailer. Graphical coding is used to deliver information and advertising to a consumer, but again the advertising delivered is typically one off and does not reflect preferences of the individual card holder consumer. There are presently no loyalty and discount cards on the market that allow a first retail establishment to offer to its customers discounts at other noncompetitive retail establishments. This would provide a new means for the first retail establishment to offer clients an additional service and at the same time guide these same clients to the other, otherwise unrelated establishments. There is a need for a new system and for methods to enable a new loyalty and discount card that can provide links related to multiple businesses, that can be changed over time and can reflect business preferences, advertiser preferences and user/consumer preferences.

### DISCLOSURE OF THE INVENTION

The invention includes systems and methods for loyalty and discount card transactions. The system includes a centralized server that is programmed to accept electronic requests from a network connected consumer and initiate actions based upon those requests that reflect preferences set by the consumer, businesses and advertisers. Nonlimiting examples of actions include delivering advertising content from advertisers to the consumer, providing special pricing or discounts to be used by businesses to the benefit of the consumer and collecting, storing and further disseminating information regarding the actions. The information may be disseminated to the consumer, businesses, advertisers or other interested parties. In one embodiment, the loyalty and discount card is first provided to the consumer through a primary service provider. Prior to delivery to the consumer a promoter has contracted with other participants to provide content delivery, discounts, and requests for information. The participants in the process include a 1) a promoter, 2) a primary service provider, 3) a card provider, 4) a plurality of retailers and advertisers and 5) a customer of the primary service provider. The promoter enrolls primary service providers, retailers and advertisers and engages a card provider to host the system. Exemplary primary service providers include rental car companies, hotels, airlines and other companies that offer temporary contracts to their customers. Exemplary retailers include any retailer from whom a customer of the primary service provider is likely to purchase goods or unrelated services during the duration of the contract with the primary service provider. Thus, exemplary retailers include gas stations, hotels, restaurants and tourist attractions. In one embodiment a card provider provides a primary service provider with a supply of cards. The primary service provider, in turn, distributes the cards to their customers upon activating a new short term contract and activates the cards. The activation process includes loading the consumers' identification information (email, phone, and address, etc.) onto the card. This identification information is sent directly to card provider's data base. The customer then presents the card to any of the enrolled retailers selected by the primary service provider when making a purchase. The card is scanned and the user identification information is matched against the card provider data base which in turn checks the primary service provider data base to be certain a contract between the primary service provider and the customer is currently active. If such a contract exists and the information is verified against pre-set preferences, the customer receives a predetermined discount and/or advertisement from the retailer. Preferences can be set by all participants of the system. The consumer may be interested in only discounts, or only certain types of businesses. The retailers and advertisers may set preferences to deliver content to only consumers that meet certain requirements. An example of such requirements is that the consumer has a contract with a particular retail business such as a car rental company. The primary service provider sets preferences such as to deliver content from particular businesses who have contractually agreed to terms with the service provider. Alternatively the service provider may deliver any available advertising content. The service provider's preferences may be set to deliver content in a certain priority and the priority can be changed over time. Exemplary changes include delivery of an advertisement a limited number of times. Discounts may be delivered limited to a predetermined number of units being sold. Preferences of the retailer/advertiser may include offering discounts on a particular item limited to the stock on hand, including limiting discounts to particular locations and inventory at those locations. The Number of times may be determined contractually between the service provider and the retailer/advertiser. The system is not limited to single businesses. Multiple businesses may all deliver content simultaneously or sequentially to the consumer. The need for a consumer to carry multiple loyalty and discount cards is eliminated. The functionality of the loyalty and discount card that is carried by the consumer may be changed through recorded preferences. The preferences may be programmatically changed on the basis of usage and results. The centralized management and recording of preferences allows a loyalty and discount card that can be changed to meet all participants' needs.

In another embodiment a second contract exists between the card provider and the retailer in which the card provider is paid a fee through the promoter for directing the customer to the retailer based upon identification information encoded in the discount. In this fashion a retailer pays only for that traffic directed at his establishment that actually makes a purchase. The card provider tracks the use of the card and thereby creates a database that demonstrates the effectiveness of the card discount process. The primary service provider typically pays the card provider a fee through the promoter based upon the number cards distributed.

In another exemplary embodiment, the primary service provider is a rental car company. The card provider provides a custom key chain holder that contains one of the temporary rewards cards to the rental car company. The key chain holder is placed on every one of the cars available for rent. When a customer executes an automobile rental contract with the primary service provider, they receive the custom key chain holder with the temporary discount card attached. The sales person at the primary service provider registration desk explains to the customer that as a reward for renting their vehicle they have the right to use the discount card at any of the locations listed on the back of the card. On the front of the card is the rental car company name and a customer service telephone number. The sales agent activates the temporary card, and all of the customer data is downloaded onto the card and also forwarded to the card provider data system. The rental car agent also explains to the customer that they return the card when they return the car. When the car is returned, the agent deactivates the card.

When the primary service provider customer uses the activated card at an enrolled retailer, the customer receives a predetermined discount on the goods or services purchased. The discount is tracked by scanning or swiping the card into the retailer point of sale system where the encoded customer information is down loaded and transferred to the card provider system. The customer receives the discount, and the discount card provider receives a fee for directing the customer to the retailer. The card can be used as many times as desired throughout the rental period, and used at any of the enrolled retailers selected by the primary service provider. When the customer's rental period expires, they return the card and it is deactivated.

In one embodiment the loyalty and discount card is a Temporary key (FOB) chain and targeted to the travel industry. The service provider provides the fob to a car rental agent, a first retailer participant. The card is preprogrammed to deliver advertisements to the card user clients (the consumer participant). The FOB will be activated at the time the new user (the consumer) visits the rental car company. The consumers use the Temporary key (FOB) chain, and then they receive all the advertising on the Temporary key (FOB) chain from retail partners participants. The service provider tracks all the activity on the Temporary key (FOB) chain and collect the information at the end of each day. The service provider thereby not only helps track the vehicle, but can also offer advertising and revenue sharing to other participants as the user uses the fob and receives discounts to other retailer participants. In a preferred embodiment the service provider provides a custom key FOB chain to a car rental company that is encoded to deliver advertising messages from a plurality of retailer participants. The Temporary key (FOB) chain holder is placed on every one of the cars available for rent. The customer (consumer) rents a car, and instead of just getting the key as they currently get, they receive the custom key FOB chain holder and advertising messages that are delivered through the invented process. The sales person at the car rental desk explains to the customer that as a thank you for renting their car they have the right to use the Temporary key (FOB) chain and they will be able to download discounts offered at any of the locations listed on the back of the card. On the front of the card is the car rental company name and the 800 customer service phone number. The sales agent activates the Temporary key (FOB) chain. When the car is returned, the agent deactivates the Temporary key (FOB) chain, and the history of all the activity is logged by the service provider and sent to data user participants.

Examples of participant retailers include fast food, gas, coffee, mini mart etc. This can be duplicated as long as the consumer has the rental car, and can be done as many times as the wish through out the rental period, and used at any one of our advertising companies. The consumer may use the car repeatedly through the rental period. The programmability of the actions as described below will allow the consumer to receive additional or different discounts with each use or perhaps simply over time. The consumer then will turn the Temporary key (FOB) chain in with return of the rental car and it is deactivated. All the activity is logged and sent to data user participants. In a preferred embodiment a daily report for all the cards is prepared and sent data user participants.

### BRIEF DESCRIPTION OF THE DRAWINGS

FIG. 1 is a block diagram of a system for practicing the invention.

FIG. 2 is a block diagram of an embodiment of the invention.

FIG. 3 is a view of an embodiment of a loyalty and discount card.

FIG. 4 is a flow chart of an embodiment of the invention.

FIG. 5 is a diagram showing a user preference filters embodiment of the invention.

FIG. 6 is a block diagram of participants in an embodiment of the invention.

### MODES FOR CARRYING OUT THE INVENTION

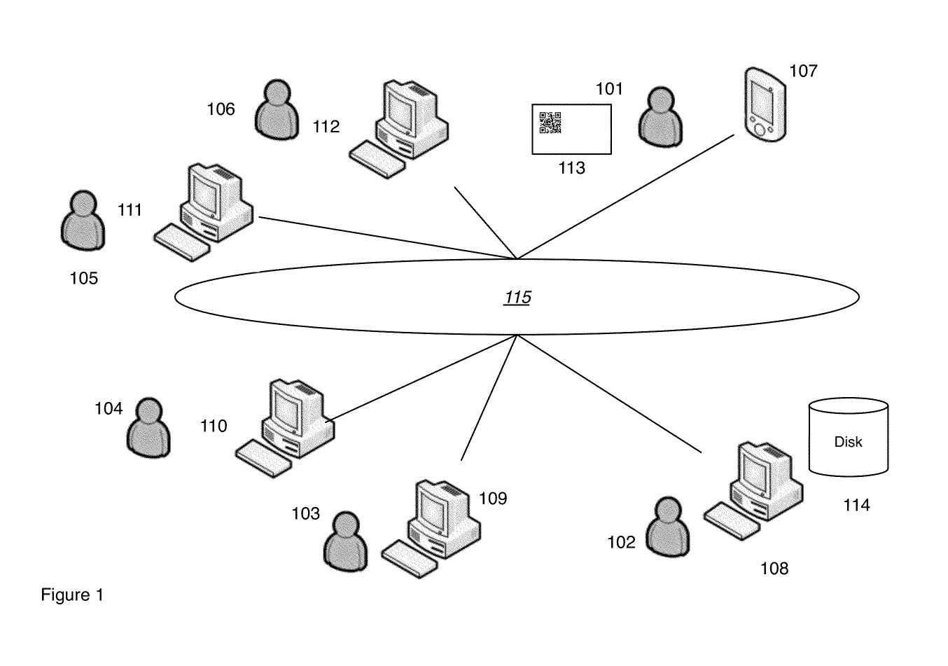

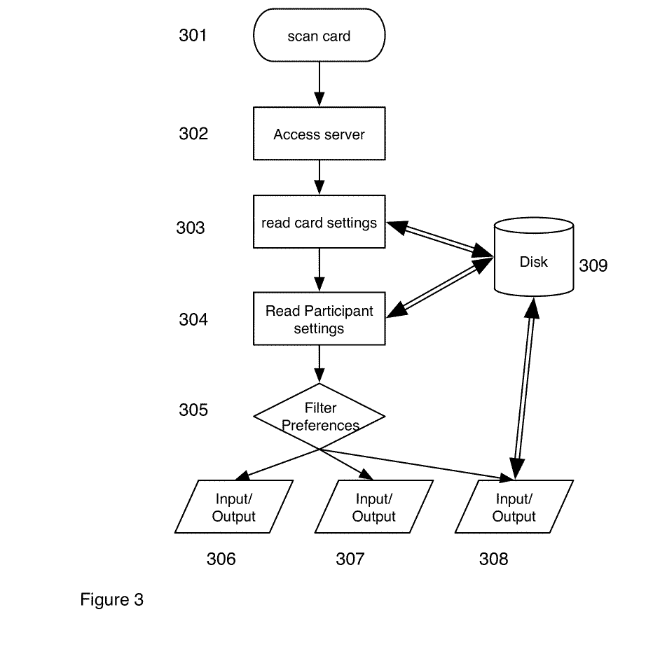

Referring now to FIG. 1, a block diagram of a system for practicing the invention is shown. Participants 101-106 include a consumer user 101, a service provider 102 one or more retailers/advertisers 103, 104 a promoter 105 and a data user 106. The participants interact with the system through computing devices 107-112. Nonlimiting exemplary computing devices include smart phones, portable electronic devices, personal computers and file servers. In one embodiment the consumer's 101 interaction with the system is facilitated through a loyalty and discount card 113. The details of the loyalty and discount card are discussed below in conjunction with FIG. 3. The service provider 102 computing device 108 further includes storage 114. The storage is used to maintain a database of participants' use preferences. The service provider's computing device 108 is programmed to deliver content to other participants. Non-limiting exemplary content includes an advertisement, discount information, driving directions to an establishment and instructions to create an appointment at a retailer.

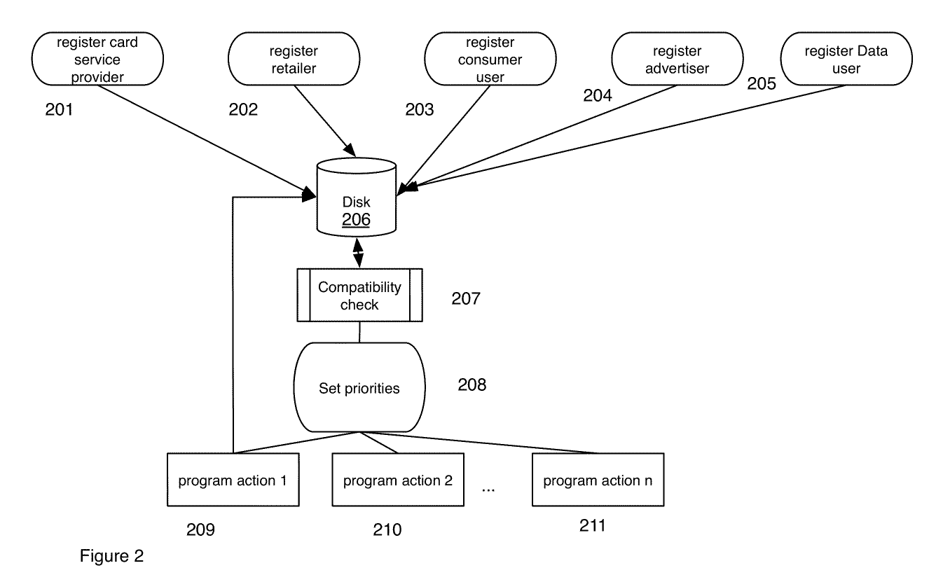

Referring now to FIG. 2, a service provider who will provide the cards and management of the system 201 registers their preferences that are stored to memory of a server. The participant that distributes the card may be a separate service provider or a retailer. Note that a single retailer can distribute a card that will be pre-programmed with preferences set by a plurality of other retailers. A single card may be used to provide content and discounts from multiple retailers. The need for multiple loyalty cards is eliminated. Similarly retailers register their preference 202 as do consumer users 203, advertisers 204 and data users 205. All preferences are stored on a server 206. Every preference has at least one associated action. Preferences and the associated actions are then checked for mutual compatibility 207. Actions that are determined to be mutually logically incompatible are then given a priority ranking 208 versus the other logically incompatible preference actions such that when the card is used the action with the higher priority ranking would be taken to the exclusion of the other logically incompatible preference actions. The priorities are programmed 209-211 into the system for every action such that the system may automatically match actions and priorities and take actions with no further intervention.

Upon accessing the server the registration of the user is matched 208 to the database of the registrations and recording of preferences 201-205. The preferences are then filtered 209 resulting in selection of pre-programmed actions to be taken upon discovering a mutually compatible set of preferences. The set of actions are then initiated 210, 211, 212. Non-limiting exemplary actions include display of a discount coupon on the consumer user computing device, display of web page contents on the consumer user device, alert sent to the retailer that a registered consumer is entitled to a discount, said discount encoded in the retailer preferences, an initiation of content download from an advertiser server, report to a data user of the access by the consumer user.

Exemplary participant's preferences are included in Table 1. Each preference has an associated action for each alternative result. The card service provider may have preferences that a participant accessing the system must be a registered user and the associated actions are that a response is given to the user if they are a registered user and that the use of the card is ignored if the user is not a registered user.

TABLE 1
Preferences and Actions

| Card service | | Consumer | | |
|---|---|---|---|---|
| provider | Retailer | Card User | Advertiser | Data User |
| IF a registered | If Registered | If registered, | If registered user, | If registered |
| User acknowledge | User give | Discounts | Display ads for all | user, Display |
| card | discount | only | registered retailers | Card User data |
| If not a registered | If not a registered | If registered, | If not registered, | If not registered |
| user offer | user display | Local Discounts | Display ads | user, Display summary |
| registration process | advertisement | Only | for all retailers | data all categories |
| | For all users | If not registered, | If registered user, | For all user, Display |
| | Advertise Only - | Privacy | Display ads only if | summary data selected |
| | No discounts | settings | discount given | categories |

Table 1 Exemplary Preferences

An alternative associated action for the preference would be that anyone accessing the system may receive content and services. A retailer likewise might give a discount to registered users or if not a registered user display advertisement only. A consumer user might have preferences of only to receive content related to discounts or only provide content to local discounts. A user can have privacy preference settings with the associated action of provide no content at all or provide only content from select retailers. An advertiser preference may provide content from all registered retailers at the prompting of use of the card or an alternative preference may be set to display any advertisement content that is available. Similarly Data users may have a preference set to show all card use data or the preference may be set to display summary data in select categories. Each individual participant may set their individual preferences. Multiple participants interact with the system simultaneously.

Actions by the system in response to use of a card by a consumer are determined by filtering through the preferences of all participants. Filtering means determining actions that are mutually compatible with the preferences set by all users. It can be seen that there may be actions that are not mutually compatible. For example a user may state they wish to receive content only from specific retailers and advertisers and the retailers and advertisers may have preferences set to send content to all card users. The actions proscribed by the user are logically incompatible with the actions proscribed by the retailer and advertiser. The incompatibility of the actions is resolved by each set of logically incompatible actions having a programmed priority ranking versus every other mutually logically incompatible action. Therefore as preferences are filtered those actions that are known to be logically incompatible with other actions are flagged. The first pass filtering of preferences sets flags for logically incompatible preferences, the second pass filtering would resolve the ranking of the logically incompatible actions and a third pass would take the actions with the higher priority ranking. Filtering preferences is therefore a multipass process to determine compatibility of actions before the final actions as a result of use of the card are actually taken. Flagging logically incompatible actions and setting priorities is part of the registration process for each participant. Priority rankings are determined prior to use of the card.

As an explanatory example presume the participants have selected the set of preferences as shown in Table 2. A consumer card user use a card accessing the server whose program then responds by matching the registration of the user and filtering by the preferences as shown in Table 2. The card service provider has required that the user must be a registered user. The first filter is then whether the card is known to be used by a previously registered user. The preferences and associated actions for each participant are then compared. It is seen that the preferences and actions of the card service provider, retailer, consumer card user and data user are all compatible That of the advertiser indicates to take an action, display ads for all registered retailers even if the card user is not registered. This action is not compatible with the other programmed actions. The priority of this action is therefore compared with that of the other preferences/actions and this action is flagged no to take place as it is seen to have a lower priority than the other logically incompatible actions. If the priority of the advertiser action is set to 2 rather than 0 as displayed. Then the action under advertiser would take place despite the preference settings of the other participants since its priority, 2 would exceed the priority, 1, of the other logically incompatible actions. The actions of the card are therefore seen to be variable and programmable based upon pre-programmed actions and priorities. Actions include changing the priority for logically incompatible actions. The actions are therefore seen to be programmable and can vary with use of the card.

TABLE 2
Example Process Preferences

| | Card service | | Consumer | | Data |
|---|---|---|---|---|---|
| Participant | provider | Retailer | Card User | Advertiser | User |
| Actions | if registered User | If Registered | If registered, | If not registered | Display |
| | proceed with actions | User give | display Discounts | user, Display ads | Card |
| | else provide | discount | only, no other | for all registered | User |
| | registration | | advertisements, | retailers | data |
| Priorities | 1 | 1 | 1 | 0 | 1 |

Referring now to FIG. 3, user of the card is shown. A consumer user scans the card 301 using a computing device. In a preferred embodiment the computing device is a portable device such as a tablet or smart phone. The scanning results in a program initiated on the consumer's device that initiates access to the server 302 that is managing the overall process. The access 302 may be as access to a web page whose URL is programmed in the loyalty and discount card possessed by the user. The server then reads the setting 303 to determine the appropriate set of preferences to be applied for the particular card being used. The preferences are then also read 304. The card registration and preferences are stored in memory associated with the server 309. Both are set prior to use of the card as discussed in association with FIG. 2. Preferences are then filtered 305 and appropriate actions are taken 306-308. In one embodiment the actions 308 include further access to the stored parameters and preferences in the server memory 309. Therefore a use of the card may set or reset preferences for one or all of the participants.

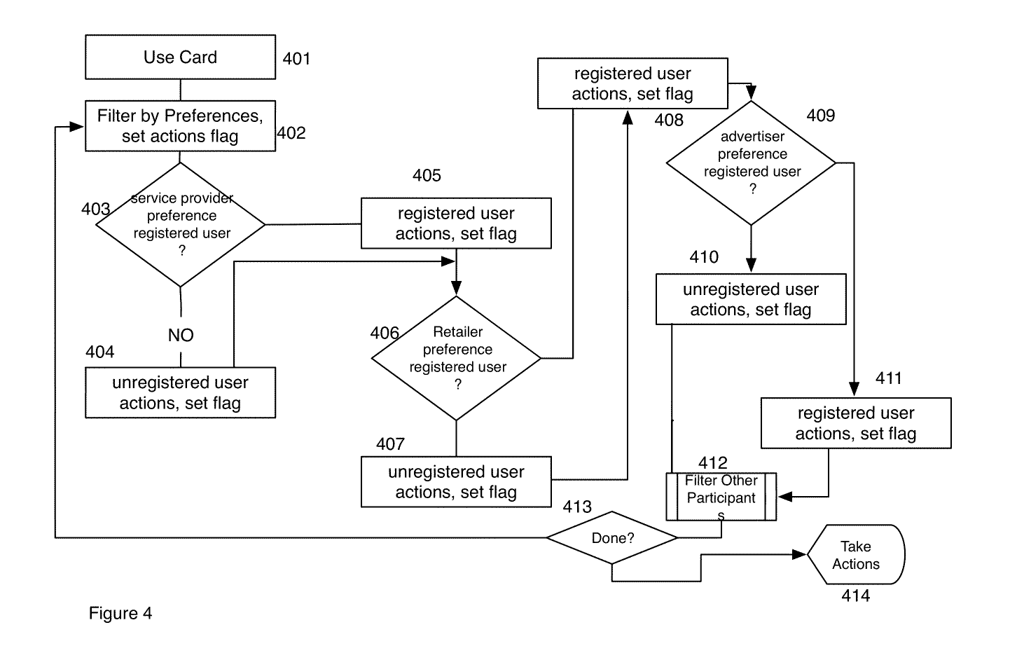

Referring now to FIG. 4, the filtering process is described. A consumer/users uses the card 401. Use means suing the card to identify and connect to a server running the loyalty and discount card system program. In a preferred embodiment the loyalty and discount card is encoded with a url that connects to a web page on the server. Once activated by the use 401 the system filters by preferences 402-413. As a non-limiting example a preference is set regarding whether the user is a registered user of the loyalty and discount card. Each participant has preferences set regarding actions to taker relative to a registered and non-registered user. The filtering process accesses the pre-set preferences in turn. On a first pass the action flag is set 402 to take no action until discrepancies between actions and participant preferences are resolved. The service provider preferences are checked 403 and a flag is set as to whether the user is 405 or is not 404 a registered user. Similarly the retailer preferences are checked 406 and again flags are set for a registered 408 or non-registered 407 user and actions to be taken on the basis of the Service provider's preferences. Similarly the advertiser preferences are checked and flags set accordingly 409-411. The same process is continued for all other participants 412. The process continues to check 413 whether all logically incompatible actions have been cleared. Cleared means that where two actions are found to be logically incompatible the action with the lower priority set during the registration process is flagged to not happen and the action with the higher priority will be taken. Once all logically incompatible actions have been sorted and flagged for priority then the actions proscribed during registration take place 414. Non-limiting exemplary actions include delivery of advertisements, discount coupons, directions/instructions or other content to the user via their portable electronic device, logging of data based upon the use by the consumer/participant and reporting use data to other participants and reprogramming the card by changing the priorities for logically incompatible actions.

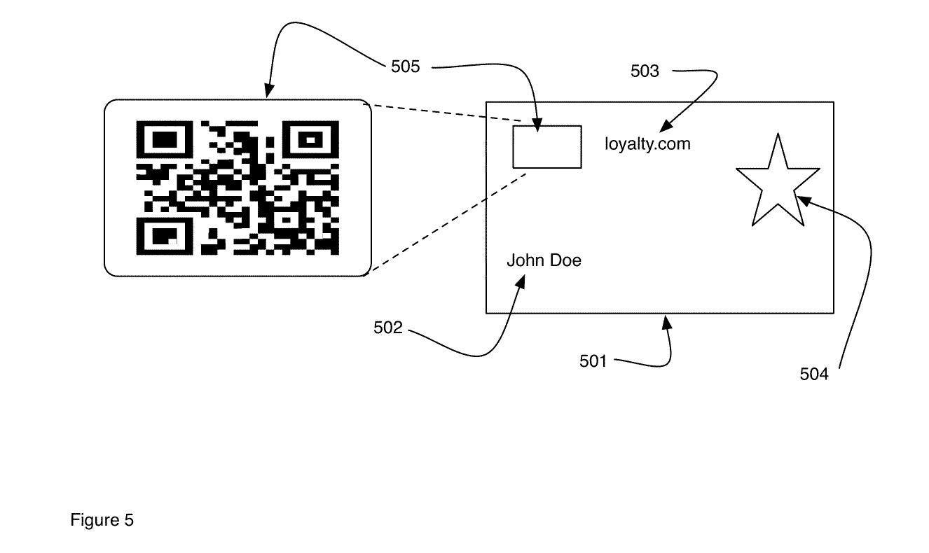

The form of the loyalty and discount card in a preferred embodiment is shown in FIG. 5. The card 501 consists of identification information 502-504 and a means 505 to encode an electronic address to a server that is programmed to take actions and deliver content to the user and other participants upon use of the card. Exemplary means to encode the electronic address include a QR code ® as shown, RFID tags and other electronic tags know in the technology. Exemplary identification information includes a user name 502, a retailer or participant name 503 or a URL for connection to the service 503 and a brand indicator 504. In use the card user activates their portable electronic device by scanning or otherwise interacting as appropriate with the encoded electronic address 505 and their portable electronic device then interacts with the server that delivers content. In another embodiment the “card” is encoded as an application on the portable electronic device and a physical card is not needed. In a preferred mode the consumer computation device is a portable electronic device like a smart phone and the connection is through accessing a web page through a url encoded on the loyalty and discount card. The exemplary credit card-like device described herein could be embodied alternatively as a barcode device, a wireless dongle, a cell phone application, an RFID tag or a wireless “smart” card with appropriate modifications

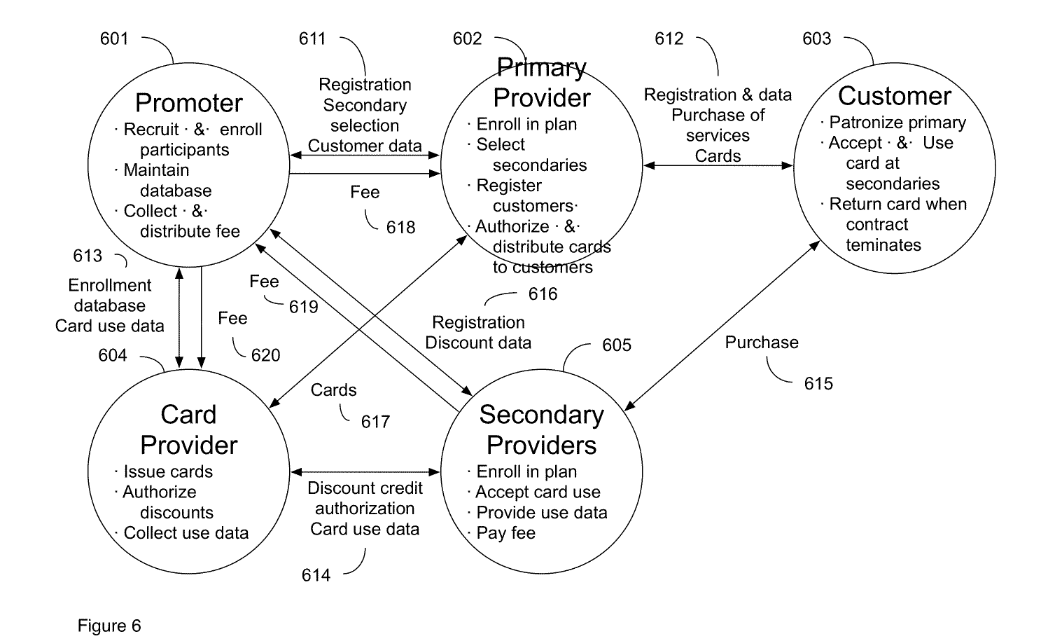

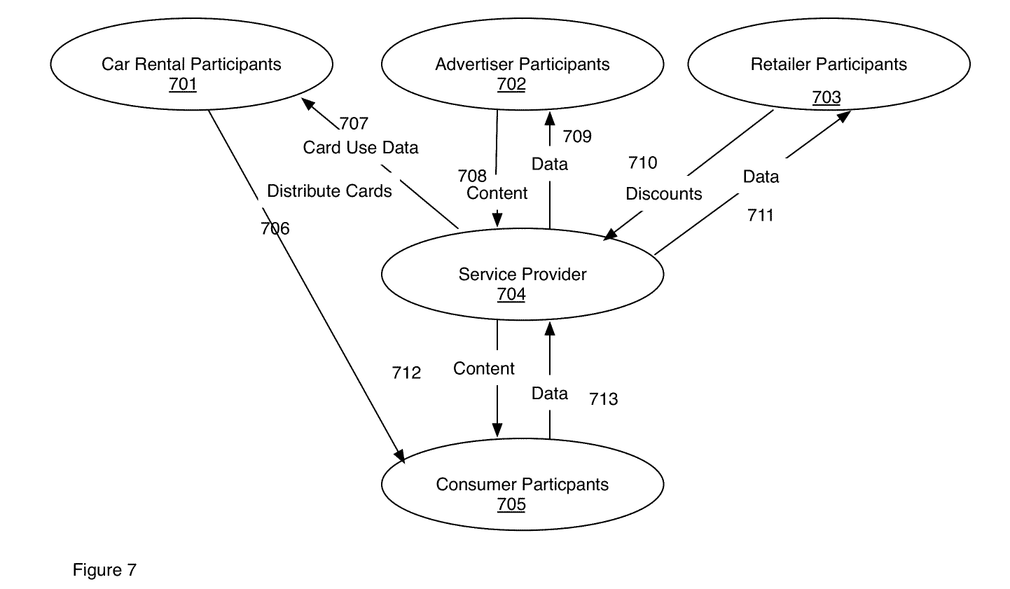

Referring now to FIG. 6, the functions of the participants and their interrelationships that form another embodiment of the invention are described. The promoter 601 recruits and enrolls participants in the system, including the primary service providers 602, the secondary providers of goods and services 605, and the card provider 604 which hosts the discount system. The promoter 601 also maintains a comprehensive database including participants, agreed discounts, and customer and card use data. Additionally, the promoter collects operating fees 619 from the secondary providers 605 and distributes them to the appropriate participants. The promoter exchanges 611 primary provider 602 enrollment information, secondary provider selections and customer 603 data with the primary service provider 602 and provides a percentage of the fees 618 to the primary service provider 602. The promoter further exchanges 613 provider enrollment database information and card use data with the card provider, and provides a fee 120 paid to the card provider based on the total number of discount cards issued to primary providers 602.

Primary service providers 602 enroll in the plan through contact with the promoter 601 and select from a comprehensive list of enrolled secondary providers 605 to establish a custom list which is made available to their customers 603. The primary service provider 602 registers their customers 603 with the promoter 601 and authorizes and distributes discount cards to their customers 603 upon execution of a contract for their services. The primary service provider 602 exchanges 612 registration information with the customer 603, as well as receiving compensation for the contracted services and providing authorized discount cards to them. The primary service provider 602 receives the discount cards 617 from the card provider 604.

Customers 603 patronize the primary service providers 602 and accept and use the discount cards for purchases 615 at the selected secondary providers 605. Customers 603 return the discount card to the primary service provider 602 when the contract for services expires.

The secondary service providers 605 enroll in the system through the promoter 601 and accept use of the discount cards furnished by the card provider 604 when properly authorized by the card provider 604. The secondary provider 605 acquires card use data and provides it 614 to the card provider 604. The secondary provider 605 pays a fee 619 to the promoter 601 based on the actual discounts awarded in the system. The secondary provider 605 also exchanges 616 enrollment data and a list of the agreed discounts with the promoter 601.

Card provider 604 is engaged by the promoter 601 to host the discount card system. The card provider 604 issues the discount cards to enrolled primary service providers 602 and authorizes discounts through communications 614 with the secondary providers 605. The card provider 604 also collects card use data from the plurality of secondary providers 605 and provides comprehensive card use data 613 to the promoter 601.

A preferred embodiment of the invention is displayed in FIG. 7. Participants include car rental companies 701, advertisers 702, retailers 703, a service provider 704 and consumers 705. The Service provider 704 manages the system through a programmed server connected electronically to all participants. Participants are pre-registered with programmed preferences, actions and priorities for those actions where logically incompatible actions are proscribed. The car rental company distributes cards 706 to consumers 705 who come in to rent a car and are registered at that time and given a card or similar means to interact with the system as already described. Consumers 705 preferences and actions may be set at the time of registration or be preprogrammed with default user settings and preferences for all consumer car rental customers. Each participant, through operation of the system is seen to deliver and receive something to other participants. The car rental participant delivers cards 706 to its rental customers 705. The car rental participant receives in return card use data 707 via the service provider. Similarly the advertiser delivers advertising content 708 either through the service provider as shown or directly tot eh consumer (not shown). The advertiser receives in return data related to delivery of content. The data may in fact be directly related to payments or expenses in a pay per view and pay per click system as known in the art. The retailers deliver discounts 710 and in return receive data 711 related to usage that may included information related to the effectiveness of discounts to draw customers. The consumer receives the card and by use receives content 712. Content may include advertisements, discounts or other information relevant to the consumer such as directions or instructions for accomplishing certain tasks. The consumer in return delivers data 713 regarding their use of the system.

In another embodiment, not illustrated, but performed as shown in FIG. 7 the car rental participant is replaced by a car dealer and content delivered to the consumer may include advertising as shown but may also include instructions related to a purchased vehicle. Instructions may include reminders that a service is required and instructions for automatically setting up appointments with the service department. Similarly a physician participant may use the loyalty and discount card system to direct content to patients. Content may include appointment reminders and prescription instructions. Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

### SUMMARY

A programmable loyalty and discount card system and methods is described. The card is programmable through pre-set and updateable preferences and actions associated with the preferences. Logically incompatible actions are reconciled at time of use of the card through priorities set at the time of initial registration. Participants and users of the system may include multiple retailers, consumers and data users who provide the service to consumer participants through a service provider.

What is claimed is:

1. A method for programmably providing content to consumers comprising:
a) registering a plurality of participants, said participants including at least one consumer and at least on selected from each of a service provider, a retailer, a content provider and registering includes recording to memory of a computer server preferences, actions associated with each preference and a priority for logically incompatible actions,
b) providing the consumer an electronically encoded address of the server,
c) activating the system by the consumer electronically contacting the server through the encoded address,
d) programming the server to:
i) filter the recorded actions, wherein filter means selecting those actions that are logically compatible with all other actions or if logically not compatible, have a higher priority, and,
ii) to take actions that are selected by the filter step, wherein take the actions includes delivery of content from at least one of the other participants to the consumer participant.

2. The method of claim 1 wherein content includes discount coupons.

3. The method of claim 1 wherein the recorded actions include delivery of data to participants, said data including use information said use information including the number of times the consumer user has electrically contacted the server.

4. The method of claim 1 wherein actions include changing at least one of the recorded priorities.

5. The method of claim 1 wherein the consumer electronically contacts the server through use of a URL and a cellular telephone.

6. The method of claim 1 wherein at least one of the participants is a rental car provider.

7. The method of claim 1 wherein content includes advertisements.

8. The method of claim 6 wherein content includes advertisements that are provided by a retailer who is not the rental car provider.

9. A system for programmably providing content to consumers comprising:
a) a computer server and a personal computing device said server and computing device capable of electronic communicating,
b) said computer server programmed to:
i) register a plurality of participants, said participants including at least one consumer and at least on selected from each of a service provider, a retailer, a content provider and registering includes recording to memory of a computer server preferences, actions associated with each preference and a priority for logically incompatible actions,
c) a loyalty and discount card provided to the consumer said card including an electronically encoded address of the server,
d) said computer server further programmed to be activated by the consumer electronically contacting the server through the encoded address,
e) said computer server further programmed to:
i) filter the recorded actions, wherein filter means selecting those actions that are logically compatible with all other actions or if logically not compatible, have a higher priority, and,
ii) to take actions that are selected by the filter step, wherein take the actions includes delivery of content from at least one of the other participants to the consumer participant.

10. The system of claim 9 wherein content includes discount coupons.

11. The system of claim 9 wherein the recorded actions include delivery of data to participants, said data including use information said use information including the number of times the consumer user has electrically contacted the server.

12. The system of claim 9 wherein actions include changing at least one of the recorded priorities.

13. The system of claim 9 wherein the consumer electronically contacts the server through use of a URL and a cellular telephone.

14. The system of claim 9 wherein at least one of the participants is a rental car provider.

15. The system of claim 9 wherein content includes advertisements.

16. The system of claim 14 wherein content includes advertisements that are provided by a retailer who is not the rental car provider.
